(19) United States
(12) Patent Application Publication
(10) Pub. No.: US 2003/0206163 A1
(43) Pub. Date: Nov. 6, 2003

(54) LCD with photo-detecting capability and control method thereof

(76) Inventor: Yew-Peng Kee, Taipei (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/198,945

(22) Filed: Jul. 18, 2002

(30) Foreign Application Priority Data
Dec. 31, 2001 (TW) 90133330

(51) Int. Cl. G09G 5/00

(52) U.S. Cl. 345/204

(57) ABSTRACT

An LCD with photo-detecting capability. The LCD includes a photo-detecting device to detect environmental brightness and a processing device to control display brightness according to the returned environmental brightness value. When the environmental brightness value is greater than a predetermined brightness value stored in the processing device, a low display brightness mode is applied to the LCD. When the environmental brightness value is lower than the predetermined brightness value, a high display brightness mode is applied to the LCD. When a user turns off light and leaves without powering off a computer equipped with the LCD, i.e., environmental brightness value is zero, the processing device automatically turns off the display frame until the LCD is powered on again.

### BACKGROUND OF THE INVENTION

1. Field of the Invention

The invention relates to an LCD with photo-detecting capability and a control method thereof, especially to an LCD with a photo-detecting device.

2. Description of Related Art

With continuously increasing innovation and breakthrough, current LCD monitors are light and thin with no flicker, low radiation, low reflectivity, and better physical plane. They now widely replace for conventional CRTs.

Generally, a user will choose a screensaver to protect an LCD screen on a computer. When the user has not operated the computer for a predetermined time set by the screen saver, the computer's OS will automatically start the screensaver to avoid damage due to long periods without changing frames.

However, the screensaver needs to be preset by the user in the computer for the automated start to effectively protect the LCD screen. Unfortunately, a user may neglect or forget to preset the screensaver and the computer will not automatically engage the function.

Additionally, the user has to balance the display brightness with the environmental brightness to obtain the most comfortable view. This is not convenient.

Further, if the user leaves without shutting down the computer, it not only wastes power but also easily damages the LCD due to long periods without changing frames.

Therefore, the conventional LCD is not convenient and is easily damaged.

As cited above, a novel LCD capable of overcoming the cited defects is needed.

### SUMMARY OF THE INVENTION

Accordingly, an object of the invention is to provide an LCD with photo-detecting capability and a control method thereof, which can vary with the environmental brightness to automatically balance environmental brightness of a LCD and reduce eyestrain.

Another object of the invention is to provide an LCD with photo-detecting capability and a control method thereof, which can automatically balance the display brightness for a frame displayed on a computer when a user turns off one or more circumferential lights and leaves without executing a screensaver or powering off the computer, thereby achieving the purpose of saving power and protecting LCD.

The invention provides an LCD with photo-detecting capability and a control method thereof, including a photo-detecting device on the LCD screen and a processing device in the LCD. The processing device includes a memory to store a predetermined brightness value, a microprocessor coupled to the memory and photo-detecting device to compare a predetermined brightness value and a detected brightness value and output a control signal, a driving unit connected to the microprocessor to receive the control signal and output a driving signal capable of controlling a display brightness, and a display unit connected to the driving unit to receive the driving signal and control the display brightness according to the driving signal.

### BRIEF DESCRIPTION OF THE DRAWINGS

FIG. 1 is a schematic elevation diagram of an embodiment of an LCD with photo-detecting capability according to the invention;

FIG. 2 is a block diagram of a processing device according to the invention; and

FIG. 3 is a flowchart of a control method of FIG. 2 according to the invention.

### DETAILED DESCRIPTION OF THE INVENTION

The following numbers denote the same elements throughout the description and drawings.

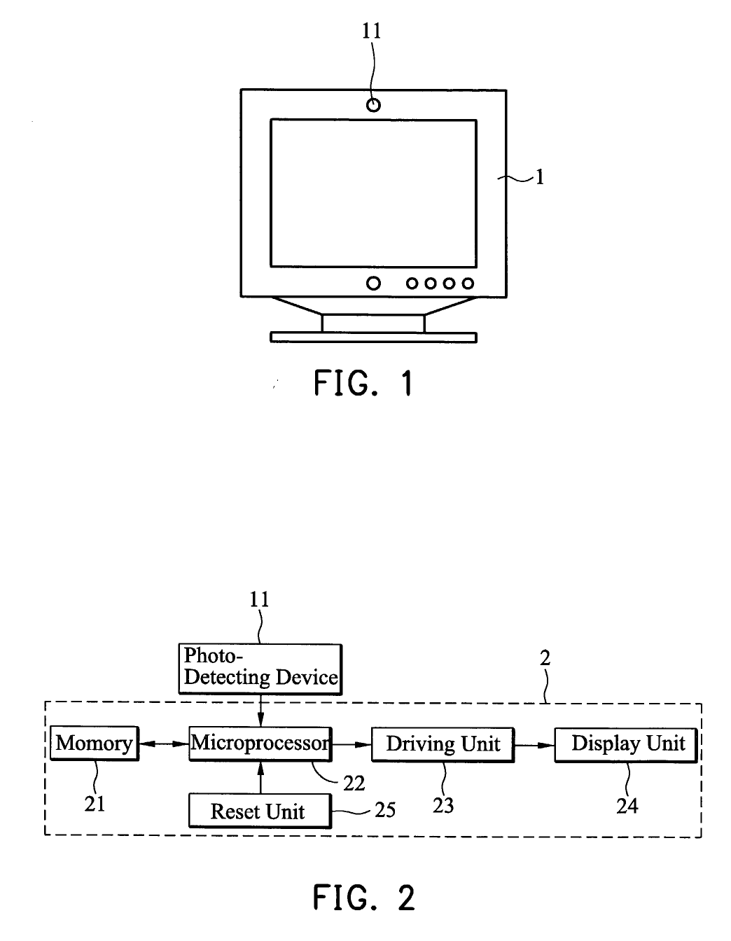

FIG. 1 is a schematic elevation diagram of an embodiment of an LCD with photo-detecting capability according to the invention. As shown in FIG. 1, the LCD includes a photo-detecting device 11, disposed on an appropriate position in the LCD 1, to detect the light source strength surrounding the LCD 1 and balance the display brightness of the LCD 1 with the environmental brightness. Thus, a user can have a light contrast (i.e., a low shading value) on the view of the LCD 1 to avoid eyestrain. The photo-detecting device 11 can be a photo-detecting resistor.

When the user turns off the surrounding light and leaves without powering off the computer equipped with LCD 1, photo-detecting device 11 detects the surrounding light strength and sends a detected brightness value to result in shutdown for the display on the LCD 1. As such, power is saved and damage from long periods without changing frames is avoided.

FIG. 2 is a block diagram of a processing device according to the invention. In FIG. 2, the processing device includes: a memory 21 to store a predetermined brightness value, a microprocessor 22 coupled to the memory 21 and photo-detecting device 11 to compare a predetermined brightness value and a detected brightness value and output a control signal, a driving unit 23 connected to the microprocessor 22 to receive the control signal and output a driving signal capable of controlling a display brightness, a display unit 24 connected to the driving unit to receive the driving signal and control the display brightness according to the driving signal, and a reset unit 25 connected to the microprocessor 22 to reset the predetermined brightness value stored in the memory 21 as desired. As shown in FIG. 2, when photo-detecting device 11 for detecting environmental brightness 1 outputs a detected brightness value to the microprocessor 22. If the detected brightness value is about zero, with little or no light emitted by the surrounding light source, the microprocessor 22 will cut off the driving signal from the driving unit 23. Thus, no display signal shows on the LCD 1. Otherwise, a further determination is made to operate in a low brightness mode or a high brightness mode. For further determination, the detected brightness value is compared to a predetermined brightness value stored in the memory 21. For adaption of difference circumstances, the predetermined brightness value can be changed by the reset unit 25 as desired. For example, when a user is accustomed to keeping some brightness in the room, the predetermined brightness value can be set higher.

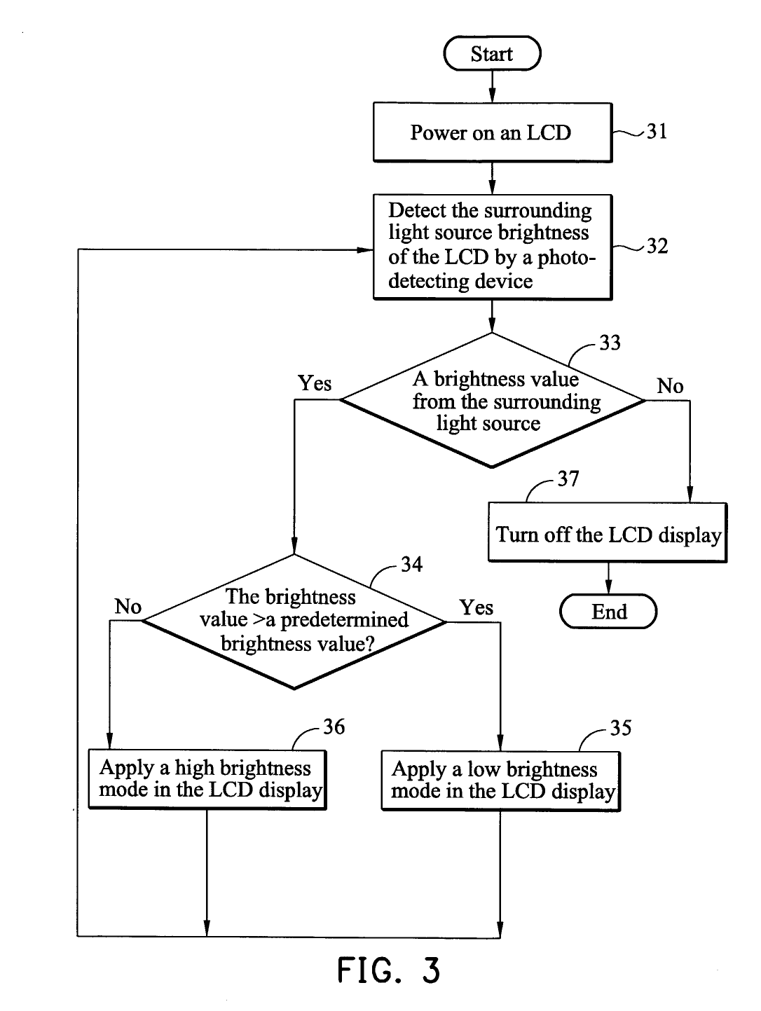

To summarize above, an operation flowchart of FIG. 2 is shown in FIG. 3 as the following steps:

Step 31: powering on an LCD;

Step 32: detecting the surrounding light source brightness of the LCD by a photo-detecting device;

Step 33: determining if a brightness value from the surrounding light source exists;

Step 34: when the environmental brightness value exists, determining if environmental brightness value is greater than a predetermined brightness value;

Step 35: when the environmental brightness value is greater than the predetermined brightness value, applying a low brightness mode in the LCD display and returning to Step 32;

Step 36: when the environmental brightness value is not greater than the predetermined brightness value, applying a high brightness mode in the LCD display and returning to Step 32; and

Step 37: when the environmental brightness value does not exist, turning off the LCD display by cutting off a driving signal from a driving unit so as to complete the operation and achieve the flexible control purpose.

In Step 34, the embodiment uses a predetermined brightness value to provide two brightness modes. However, multiple predetermined brightness values can be set to provide more than two brightness modes on the LCD display. The result of comparing the detected predetermined brightness values with the multiple predetermined brightness values can determine the display brightness.

In Step 37, the user can return to normal operation by powering on the LCD 1.

Therefore, the features of this invention are:

(1) The display brightness of an LCD with photo-detecting capability can automatically vary with the surrounding light strength.

(2) The LCD turns off the display frame if a photo-detecting device on the LCD does not detect light rays from its surrounding light source.

Although the present invention has been described in its preferred embodiment, it is not intended to limit the invention to the precise embodiment disclosed herein. Those who are skilled in this technology can still make various alterations and modifications without departing from the scope and spirit of this invention. Therefore, the scope of the present invention shall be defined and protected by the following claims and their equivalents.

What is claimed is:

1. An LCD with photo-detecting capability, comprising a photo-detecting device implemented on the LCD, to detect environmental brightness and balance the display brightness for the LCD to a level selected from: no display brightness, low display brightness and high display brightness, according to environmental brightness detected by the photo-detecting device.

2. The LCD of claim 1, wherein photo-detecting device for detecting the surrounding light source outputs a brightness value to a processing device.

3. The LCD of claim 2, wherein the processing device located in the LCD compares environmental brightness value output by photo-detecting device with a predetermined brightness value and balances a display brightness for the LCD according to the comparison result, further comprising:
a memory, to store the predetermined brightness value;
a microprocessor coupled to the memory and photo-detecting device, to compare environmental brightness value output by photo-detecting device with the predetermined brightness value stored in the memory and output a control signal;
a driving unit connected to the microprocessor, to output a driving signal to control the display brightness for the LCD according to the control signal output by the microprocessor; and
a display unit connected to the driving unit, to receive the driving signal output by the driving unit and return a shading value controlled by the driving signal on the LCD.

4. The LCD of claim 3, wherein the processing device further comprises a reset unit connected to the microprocessor, to reset the predetermined brightness value stored in the memory.

5. The LCD of claim 1, wherein photo-detecting device is a photosensitive resistor.

6. A control method for an LCD with photo-detecting capability, comprising the step of implementation of a photo-detecting device on the LCD to detect environmental brightness and output a brightness value, wherein no display frame is shown on the LCD if environmental brightness value is zero, and display brightness for the LCD varys with environmental brightness if environmental brightness value is not zero.

7. The control method of claim 6, wherein the display brightness for the LCD varies with environmental brightness further comprising the steps:
comparing environmental brightness value and the predetermined brightness value stored in the memory;
applying a low display brightness mode to the LCD when the environmental brightness value is greater than the predetermined brightness value; and
applying a high display brightness mode to the LCD when the environmental brightness value is lower than the predetermined brightness value.
